(19) United States
(12) Patent Application Publication
(10) Pub. No.: US 2012/0141653 A1
(43) Pub. Date: Jun. 7, 2012

(54) FISH DEHYDRATION APPARATUSES, METHODS, AND PRODUCTS THEREOF

(76) Inventor: Patrick J. McDonald, New Castle, DE (US)

(21) Appl. No.: 12/960,394

(22) Filed: Dec. 3, 2010

(51) Int. Cl. A23B 4/03; F26B 19/00; A23L 1/325

(52) U.S. Cl. 426/643; 426/467; 34/219

(57) ABSTRACT

Fish dehydration apparatuses, methods, and products thereof are disclosed. A fish dehydration apparatus may include an oven body, a fish suspension system, a heat source, a blower fan, and an air circulation duct. The fish suspension system may be configured to suspend fish in a substantially vertical position so that oil and other unwanted liquids may naturally drip from the fish during the dehydration process. The fish oil may be collected using a drainage system and moisture may be extracted from the internal environment using a demoisturizer. An oven controller may also be used to monitor the dehydration environment and control the heat source and blower fan during the dehydration process.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. Field

The present invention generally relates to fish dehydration devices.

2. Description of Technology

Currently available fish dehydration devices include a screen or grid tray system. In such devices, fish is often laid out on a flat screen or grid and left to dry by a natural heat source, such as the sun. Over time, the moisture within the fish is extracted until the fish reaches a desired state or degree of dehydration.

### SUMMARY

In some embodiments of the present invention, a fish dehydration apparatus includes an oven body comprising a fish suspension system configured to suspend fish in a substantially vertical position. The apparatus also includes a heat source configured to increase a temperature within the oven body. The apparatus further includes a blower fan configured to generate a flow of air that traverses a volume defined by the oven body and an air circulation duct connected thereto.

In certain embodiments, the fish dehydration apparatus also includes a demoisturizer that is configured to extract moisture within the oven body. In some embodiments, the fish dehydration apparatus may also include a drainage system configured to collect fish oil originating from the fish suspended within the oven body. In such embodiments, the drainage system may include a drain and an oil collection drawer located near a vertical base of the oven body.

The fish dehydration apparatus may also include an oven controller that is configured to control the operation of the heat source and the blower fan. In such embodiments, the oven controller may also be configured to monitor an environment within the oven body. In certain embodiments, the fish suspension system includes a plurality of rails and removable rods from which the fish may be suspended or otherwise hung. The fish suspension system may also include one or more suspension hooks.

Other embodiments of the present invention include a fish dehydration method. The method may include suspending fish inside of an oven body, which may include a fish suspension system that is configured to suspend fish in a substantially vertical position. The method may also include executing a dehydration process, including activating a heat source and a blower fan. The blower fan being configured to generate a flow of air that traverses a volume defined by the oven body and an air circulation duct connected thereto.

In certain embodiments, the fish dehydration method may also include receiving dehydration data from a user and using the data in executing the dehydration process. The fish dehydration method may also include extracting moisture within the oven body with a demoisturizer and collecting fish oil with a drainage system. In such embodiments, the drainage system may comprise a drain and an oil collection drawer near a vertical base of the oven body.

In certain embodiments, the dehydration process may be controlled using an oven controller. In such embodiments, the dehydration process may also include monitoring an environment within the oven body. In some embodiments, the suspending of the fish includes suspending the fish from one or more rails and removable rods of the fish suspension system. In addition, the fish dehydration method may include suspending the fish from one or more suspension hooks of the fish suspension system.

Other embodiments of the present invention include a fish skin that is dehydrated by a dehydration process. The process may include suspending fish inside of an oven body, which may include a fish suspension system that is configured to suspend fish in a substantially vertical position. The process may also include executing a dehydration process, including activating a heat source and a blower fan. The blower fan being configured to generate a flow of air that traverses a volume defined by the oven body and an air circulation duct connected thereto.

### BRIEF DESCRIPTION OF THE DRAWINGS

A more particular description of the present invention will now be rendered by reference to the appended Figures. These Figures depict only some embodiments of the invention and are not limiting of its scope. Regarding the Figures:

FIG. 1 is a perspective view of a fish dehydration apparatus in accordance with one or more embodiments of the present invention;

FIG. 2 is a perspective view of a fish dehydration apparatus in accordance with one or more embodiments of the present invention;

FIG. 3 is a perspective view of an upper interior of a fish dehydration apparatus in accordance with one or more embodiments of the present invention;

FIG. 4 is a perspective view of a fish suspension system in accordance with one or more embodiments of the present invention;

FIG. 5 is a perspective view of a lower interior of a fish dehydration apparatus in accordance with one or more embodiments of the present invention;

FIGS. 6A-6B are perspective views of a vertical base of a fish dehydration apparatus in accordance with one or more embodiments of the present invention; and

FIG. 7 is a flow chart diagram of a fish dehydration method in accordance with one or more embodiments of the present invention.

### DETAILED DESCRIPTION

The present invention has been developed in response to the present state of the art, and in particular, in response to problems and needs that have not yet been adequately recognized and/or resolved by currently available technologies.

As discussed above, currently available dehydration devices often use a technique where pieces of fish are laid out on a flat surface of vertically stacked trays or screens. While such devices may be effective to some extent, such devices also have significant limitations. For instance, fish produce a significant amount of oil during the dehydration process. Because the fish are laid out on a flat surface, the oil often remains on the fish during the dehydration process. In addition, even when the oil runs off one fish, the oil often lands on another fish due to the vertically stacked configuration. These and other occurrences are problematic because they can lengthen the time required for dehydration and can also cause some fish to reach the desired level of dehydration before other fish. Accordingly, among the embodiments of the present invention are solutions to dehydrating fish in a manner that overcomes these limitations.

The description and Figures presented herein demonstrate that the present invention may be practiced or implemented in a variety of embodiments. The discussion of these embodiments amounts to a complete written description that enables those of ordinary skill in the art to make and use the invention. While several embodiments are expressly disclosed herein, it should be appreciated that the present invention is not limited to the specifically disclosed embodiments. Indeed, the structures, features, operations or functions of the described embodiments may be reorganized or reconfigured to create one or more embodiments that are not specifically discussed herein, but nevertheless fall within the scope the present invention.

Further, the use of words or phrases such as “certain embodiments,” “some embodiments,” “may,” “can,” or similar language means that a particular feature, structure, function, characteristic, or benefit described in connection with an embodiment is included in at least one embodiment of the present invention. Thus, appearances of “certain embodiments,” “some embodiments,” “may,” “can,” or similar language do not necessarily all refer to the same embodiment or group of embodiments, and the described features, structures, functions, characteristics, or benefits may vary from one embodiment to another.

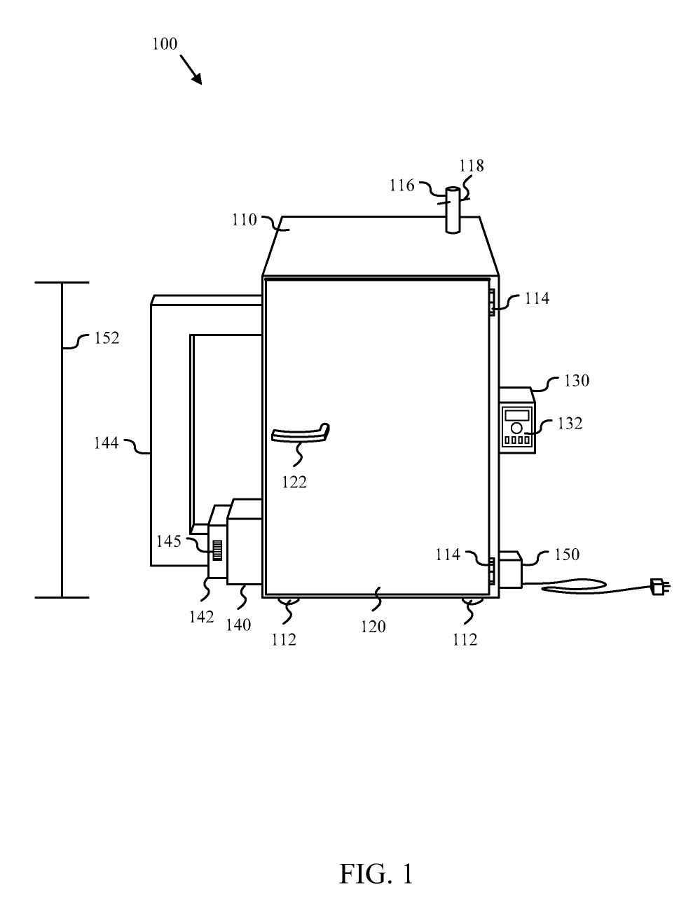

FIG. 1 is a perspective view of a fish dehydration apparatus 100 in accordance with one or more embodiments of the present invention. The depicted apparatus 100 includes an oven body 110, an oven door 120, an oven controller 130, a heat source 140, a blower fan 142, an air circulation duct 144, and a power source 150. In certain embodiments, these and other features or components of the fish dehydration apparatus 100 can cooperate to dehydrate fish in a manner that is more effective and efficient than currently available dehydration devices.

In certain embodiments, the oven body 110 provides an insulated housing for hanging fish (not shown) during the dehydration process. The oven body 110, along with other features discussed herein, may be constructed out of a variety of materials, including sheet metal of varying grades and thicknesses. The oven body 110 may also include a variety of insulators and other materials effective for maintaining a dry, warm environment inside the oven body 110. In certain embodiments, the oven body 110 may stand on a base, such as one or more legs 112, in order to stabilize the oven body 110 above the floor (not shown). In addition, the oven body 110 may include one or more hinges 114 connected to an oven door 120.

The oven door 120 may be constructed of similar materials as the oven body 110, and the oven door may include a door handle 122 to facilitate opening and closing the oven door 120. The door 120 may also include one or more locking and/or sealing mechanisms (not shown), including one or more magnet-based, latch-based, or spring-based mechanisms capable of maintaining the oven door 120 in a closed and thermally sealed position (as depicted). In certain embodiments, the door 120 may also include one or more windows (not shown), which may be constructed out of any suitable, transparent material.

The oven controller 130 may be configured to control, manage and monitor one or more dehydration processes. The oven controller 130 may consist of a variety of circuits, displays, and user interface devices 132 capable of performing or otherwise enabling a variety of dehydration monitoring and/or managing operations. For instance, in certain embodiments, the oven controller 130 may be configured to monitor and control environmental conditions within the oven body 110, such as heat, humidity, and air pressure. The oven controller 130 may also be configured to manage and monitor various dehydration timers, cycles, and modes, which may, for example, be selected depending upon the type and quantity of fish or perhaps a desired level of dehydration. In certain embodiments, the oven controller 130 may consist of multiple devices in multiple locations throughout the dehydration apparatus 100.

As such, the oven controller 130 may include or otherwise be in communication with a number of additional instruments. For instance, the oven controller 130 may be configured to receive information from one or more thermostats and one or more sensing probes (also not shown) mounted in or on the oven body 110. In addition, the oven controller 130 may be configured to use this information in controlling or otherwise communicating electrical commands to the heat source 140 and blower fan 142 to establish and maintain a suitable dehydration environment by circulating air through the air circulation duct 144. The power required to perform these operations may be provided via the power source 150, which may be configured to plug in to an electrical outlet (not shown).

In the depicted embodiment, the circulation duct 144 comprises a rigid material, such as stainless steel. However, in other embodiments, the circulation duct 144 may comprise a flexible material or a combination of flexible and rigid materials. In addition, while the circulation duct 144 of the depicted embodiment begins and ends on the same side of the dehydration apparatus 100 as the heat source 140 and blower fan 142, the circulation duct 144 may begin on an alternative side or portion of the dehydration apparatus 100. As depicted, the dehydration apparatus 100 may also include an adjustable inlet grill or vent 145 and an exhaust vent 116 with a pin-based valve 118.

The term “fish” as used herein, may include any part, segment, or portion of a fish. For instance, in certain embodiments, a fish, as used herein, may refer only to a muscle portion of a fish, while in other embodiments a fish may be embodied by a fish skin. Similarly, a fish, as used herein, may refer to different types of fish, including salmon, halibut, trout, or any other type or kind of fish. Accordingly, the term “fish” may be embodied by a variety of types and segments of a fish.

It should be appreciated that the features and components of the fish dehydration apparatus depicted in FIG. 1 may vary from one embodiment to another. For instance, in certain embodiments, the vertical height 152 of the fish dehydration apparatus 100 may be between 5-7 feet, while in other embodiments the fish dehydration apparatus 100 may only be 1-3 feet in vertical height. Similarly, while the depicted fish dehydration apparatus 100 only includes one oven door 120, it should be appreciated that alternative embodiments could include multiple doors, which could significantly increase the horizontal dimensions of the fish dehydration apparatus 100. Accordingly, as mentioned previously, FIG. 1 depicts only one of many possible embodiments of the present invention.

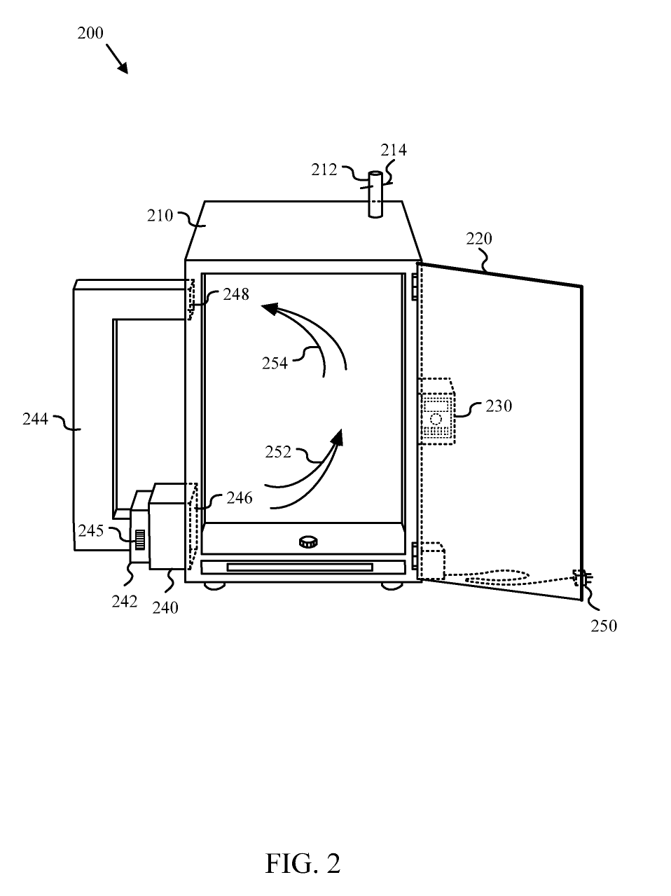

FIG. 2 is a perspective view of a fish dehydration apparatus 200 in accordance with one or more embodiments of the present invention. The depicted dehydration apparatus 200 includes an oven body 210, an oven door 220, a heat source 240, a blower fan 242, an air circulation duct 244, and a power source 250. In certain embodiments, the fish dehydration apparatus 200 may correspond to one or more of the fish dehydration apparatuses discussed elsewhere in this specification.

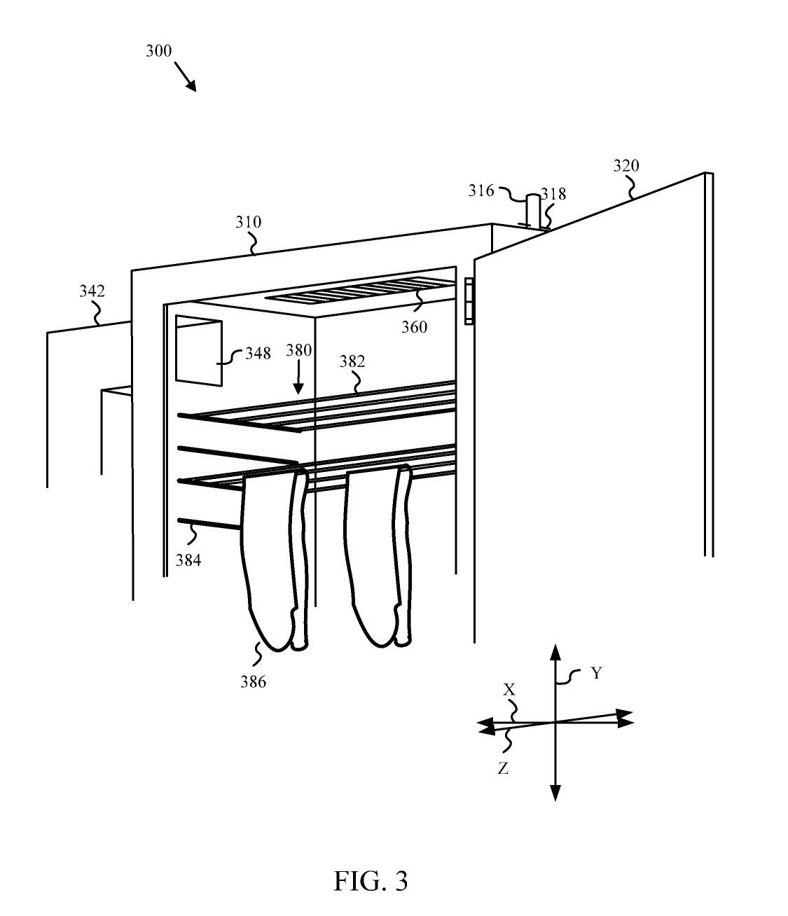

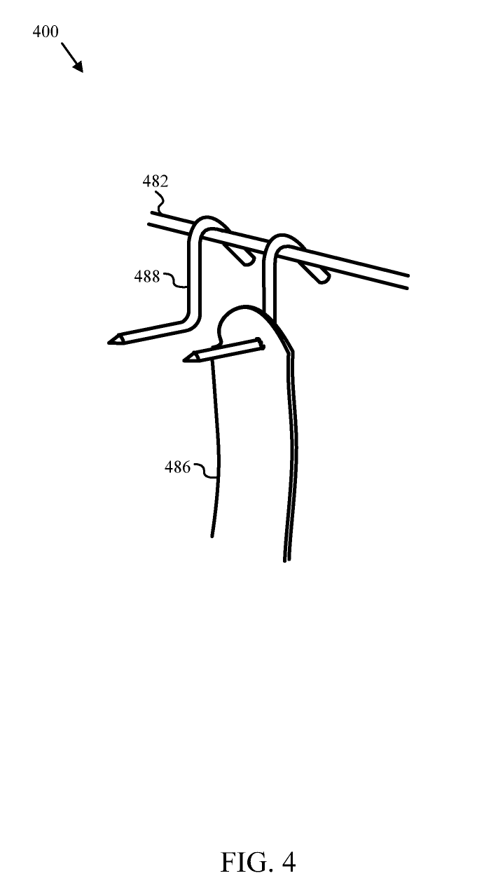

In contrast to the closed position of the oven door in FIG. 1, the oven door 220 in FIG. 2 (and also FIGS. 3-4) is depicted in an open position. This has been done so that the cooperative relationship between the oven body 210, the air circulation duct 244, the blower fan 242, and the heat source 240 might be more clearly set forth. Those skilled in the art will appreciate, however, that the oven door 220 is typically in a closed position when the dehydration apparatus 200 is actually operating.

The oven controller 230 may communicate a command or other electrical signal to the heat source 240 and blower fan 242 to begin functioning. Upon receiving the signal, the heat source 240 (or heat exchanger) may begin generating heat, which naturally increases the temperature of the air in and around the heat source 240. Also upon receiving the signal, the blower fan 242 (or air mover) may begin pushing air through the heat source 240 and into the interior of the oven body 210 via an air vent 246 near the base of the oven body 210.

Creating this warm air flow can result in an upward draft of warm air that traverses the vertical length of the oven body's interior, indicated by the direction arrows 252. Since the primary source of this newly generated air flow is the air circulation duct 244, a relative vacuum begins to form within the air circulation duct 244. As a result, in order to rebalance the air pressure within the dehydration apparatus 200, the air circulation duct 244 may begin to draw air through a vent 248 near the top of the oven body 210, indicated by the direction arrows 254.

In certain embodiments, the heat source 240 may include a heat exchanger plenum. In some embodiments, the blower fan 242 may include an appropriately positioned, adjustable inlet grill or vent 245 and an inlet mixing plenum (not shown). In some embodiments, the oven body 210 may also include an exhaust vent 212. In such embodiments, the exhaust vent 212 may be adjustable by, for example, a pin-based valve 214 that may be opened and closed according to desirable dehydration conditions. In certain embodiments, the degree to which the adjustable exhaust vent 212 is open may depend, at least in part, on the degree to which the adjustable inlet grill 245 is open.

In time, this cooperative use of heat and air pressure not only helps ensure that heat and pressure are distributed equally throughout the oven body, but it does so in a highly efficient manner. Moreover, as the dehydration processes continues, the oven controller 230 may receive heat, pressure, moisture, and other environmental information and adjust the output of the blower fan and/or the heat source 240 accordingly, to maintain or further optimize the dehydration process.

FIG. 3 is a perspective view of an upper interior of a fish dehydration apparatus 300 in accordance with one or more embodiments of the present invention. The depicted dehydration apparatus 300 includes an oven body 310, an oven door 320, an air circulation duct 342, a demoisturizer 360, a suspension system 380, and two fish skins 386. The dehydration apparatus 300 may also include an exhaust vent 316 with a pin-based valve 318. In certain embodiments, the dehydration apparatus 300 may correspond to one or more of the dehydration apparatuses discussed elsewhere in this specification.

The suspension system 380 may be configured to enable fish 386 to be hung or otherwise suspended in a somewhat vertical position, as depicted. In addition, as warm air (not shown) circulates through the oven body 310 and air circulation duct 342, the demoisturizer 360 may be configured to extract moisture out of the air to further expedite and enhance the dehydration process. The demoisturizer 360 may include a variety of demoisturizing devices. For instance, the demoisturizer 360 may include a venting stack for the removal of moisture rising out of the top of the oven body 310.

The suspension system 380 may include a variety of features and configurations. In the depicted embodiment, the suspension system 380 includes a plurality of rods 382 that are connected to a plurality of rails 384. The manner in which the rods 382 and the rails 384 are connected may vary from one embodiment to another. For instance, in some embodiments, the rails 384 may be small shelves or other protrusions upon which the rods 382 may rest. In other embodiments, the rails 384 may be cubby holes or other cavities that the rods 382 may be inserted into. The rods 382 and rails 384 may also include one or more additional features, such as grooves and hooks, to further enable the rods 382 to connect with the rails 384.

In certain embodiments, the rods 382 are removably connected to the rails 384, so that rods 382 can be added, removed, or repositioned according to a desired configuration. In the depicted embodiment, the rods 382 are positioned parallel to one another with respect to a lateral axis (Z). In order to prevent fish oil from dripping onto other pieces of fish, the rods 382 corresponding to different rails 384 can be staggered with respect to one another, as depicted in FIG. 3.

FIG. 4 is a perspective view of a suspension system 400 in accordance with one or more embodiments of the present invention. Similar to the suspension system described above with respect to FIG. 3, the suspension system 400 in FIG. 4 includes a rod 482 that can be connected to one or more rails (not shown). The suspension system 400 also includes a fish skin 486, which could also be any variety of other fish parts. However, unlike the suspension system described with respect to FIG. 3, the depicted suspension system 400 includes a plurality of suspension hooks 488, by which the fish skin 486 can be suspended in a vertical position. As such, a suspension system of the present invention may be embodied by a variety of different mechanisms and devices configured to enable fish to be hung or otherwise suspended in a substantially vertical position.

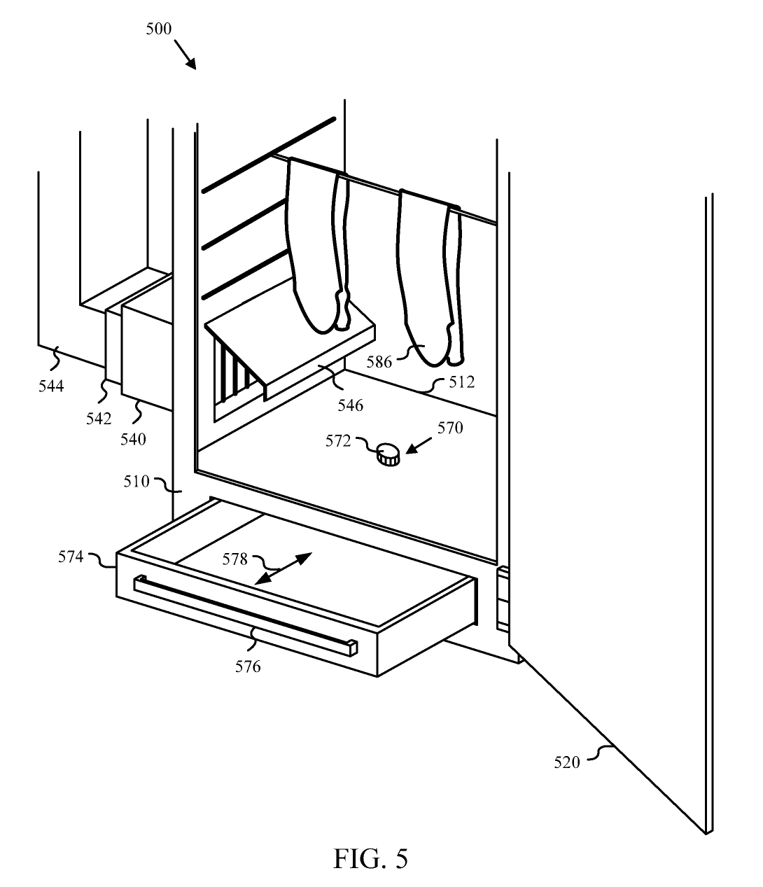

FIG. 5 is a perspective view of a lower interior of a fish dehydration apparatus 500 in accordance with one or more embodiments of the present invention. The depicted dehydration apparatus 500 includes an oven body 510, an oven door 520, a heat source 540, a blow fan 542, an air circulation duct 544, a vent cover 546, and a drainage system drain 570. The fish dehydration apparatus 500 may correspond to one or more of the other fish dehydration apparatuses discussed elsewhere in this specification.

During the dehydration process, a flow of warm air produced by the blow fan 542 and the heat source 540 may circulate through the oven body 510 and the air circulation duct 544. The warmth may cause oil and/or other liquids to drip from the fish skins 586, and these liquids may be collected by the drainage system 570, which may be embodied by a number of different structures and features.

In the depicted embodiment, the drainage system 570 includes a drain 572 that leads to a liquid collection drawer 574 near the base 512 of the oven body 510. The drawer 574 may include a handle portion 576 to facilitate moving (see, direction arrow 578) the liquid collection drawer 574 between an open and a closed position. In certain embodiments, the base 512 of the oven body 510 may be downwardly sloped toward drain 572 to better enable the drainage system 570 to collect any dripping oils or other liquids. The vent cover 546 may also be downwardly sloped to not only help with oil collection but also to shield the heat source 540 and blow fan 542 from the oils and other liquids.

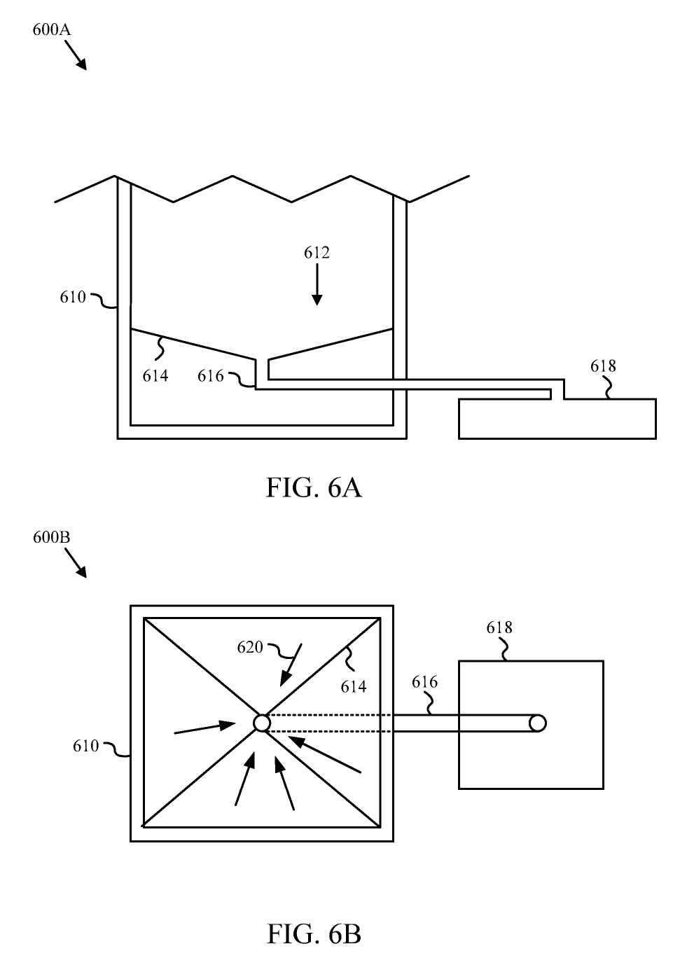

FIGS. 6A-6B are perspective views of a vertical base of a fish dehydration apparatus in accordance with one or more embodiments of the present invention. The fish dehydration apparatus 600A and 600B comprises an oven body 610 and drainage system 612. The drainage system 612 includes a funnel portion 614 for directing oils 620 and other liquid runoff from dehydrating fish (see, for example, FIG. 5) to a fluid reservoir 618 via a drainage pipe 616.

While the depicted drainage pipe 616 is presented in a substantially horizontal position, in certain embodiments, the drainage pipe 616 may be tilted downward to further enable the collection of oils and other runoff liquids into the liquid reservoir 618. In addition, in certain embodiments, the drainage pipe 616 may include a screen or other filtering mechanism to prohibit solid objects, such as falling fish skin segments, from plugging or otherwise blocking the drainage pipe 616 and the liquids passing therethrough. Further, in some embodiments, the drainage pipe 616 may be detachable from the fluid reservoir 618 to facilitate the disposal of any oils or other runoff liquids collected therein.

The flow chart diagram that follows is generally set forth as a logical flow chart diagram. The depicted order and labeled operations are indicative of at least one embodiment of the presented invention. Other steps and methods may be conceived that are equivalent in function, logic, or effect to one or more operations, or portions thereof, of the illustrated method. Additionally, the format and symbols employed are provided to explain the logical operations of the method and are understood not to limit the scope of the method. Similarly, although various arrow types and line types may be employed in the flow chart diagrams, they are understood not to limit the scope of the corresponding method. Indeed, some arrows or other connectors may be used to indicate only the logical flow of the methods. For instance, an arrow may indicate a waiting or monitoring period of unspecified duration between enumerated steps or operations of the depicted method. Additionally, the order in which a particular method occurs may or may not strictly adhere to the order of the corresponding operations shown.

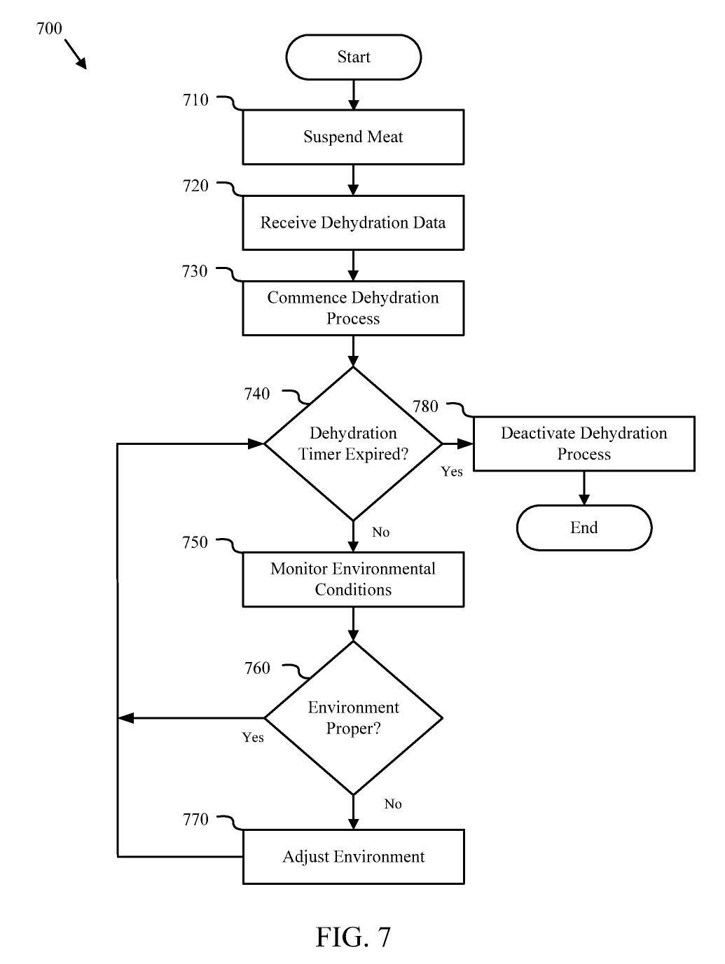

FIG. 7 is a flow chart diagram of a fish dehydration method 700 in accordance with one or more embodiments of the present invention. The method 700 includes suspending 710 fish, receiving 720 dehydration data, commencing 730 the dehydration process, determining 740 whether a dehydration timer has expired, and monitoring 750 the dehydration environment. The method 700 also includes determining 760 whether the dehydration environment is proper, adjusting 770 the dehydration environment, and deactivating 780 the dehydration process. In certain embodiments, the dehydration method 700 represents a dehydration process that may be executed by one or more of the dehydration apparatuses described elsewhere in this specification.

Suspending 710 fish may include an operator hanging or otherwise suspending one or more pieces of fish inside an oven body of a dehydration apparatus. In certain embodiments, the suspending 710 of the fish may be facilitated by a suspension system, which may include one or more rods, rails, and/or hooks (see, for example, FIGS. 3-4). In some embodiments, the fish is suspended 710 in a substantially vertical position to enable oils and other liquids to drip off of the fish and onto a base of the oven body (see, for example, FIG. 5).

Receiving 720 dehydration data may include identifying one or more settings or inputs received through an oven controller. The dehydration data may include any information that is relevant to properly dehydrating the fish. For instance, the dehydration data may include dehydration times, temperatures, targeted levels or degrees of dehydration, one or more dehydration modes, and one or more fish types, sizes, weights, densities, or other properties.

Commencing 730 the dehydration process may include activating a heat source and/or blower fan in accordance with the dehydration data received 720. In certain embodiments, commencing 730 the dehydration process includes activating a heat source and blower fan to increase the temperature and amount of air flow within the dehydration apparatus. In some embodiments, commencing 730 the dehydration process may also include extracting moisture from the internal environment of the dehydration apparatus by using a demoisturizer (see, for example, FIG. 3).

After the dehydration process has begun, the method 700 continues by determining 740 whether a dehydration timer has expired. The dehydration timer may be defined by some or all of the dehydration data that was previously received 720. If the dehydration timer has not expired, then the method 700 continues by monitoring 750 the environmental conditions of the dehydration apparatus, which may include executing a variety of operations, such as ascertaining the internal and external temperatures of the dehydration apparatus. Said operations may also include determining one or more pressures, humidity levels, and/or other environmental conditions relative to the dehydration apparatus.

After monitoring 750 the environmental conditions, the method 700 proceeds by determining 760 whether the environment is proper. In certain embodiments, determining 760 whether the environment is proper may include comparing the environmental conditions with the dehydration data that was previously received. For instance, if the dehydration data included a target temperature, then determining 760 whether the environment is proper may include comparing the internal temperature of the dehydration apparatus with the target temperature.

If the environment is proper, then the method 700 may proceed by again determining 740 whether the dehydration timer has expired. However, if the environment is improper, then the method 700 proceeds by adjusting 770 the environment accordingly. For instance, if the actual temperature is too high, then adjusting 770 the environment may include turning the heat source off for a period of time. Similarly, if the actual temperature is too low, then adjusting 770 the environment may include turning the heat source on for a period of time.

After the requisite environmental adjustments have been made, the method 700 returns to determining 740 whether the dehydration timer has expired. If not, then the method 700 repeats the operations corresponding to reference number 750, 760, and possibly 770. However, if the dehydration timer has expired, then the method 700 proceeds by deactivating the dehydration process, which may include, for example, turning off the heat source and or blower fan to avoid any unnecessary or unintended dehydration.

It should be appreciated that the embodiments of the present invention are not limited to those specifically described above. For instance, the present invention may include different structures, features, or characteristics than those described above. Similarly, methods of making and using the present invention, as described herein, may include different operations, steps, or sequences than those described above. Therefore, it is to be understood that the present invention is not limited to the embodiments described above, but encompasses any and all embodiments within the scope of the following claims.

1. A fish dehydration apparatus, comprising:
an oven body comprising a fish suspension system configured to suspend fish in a substantially vertical position;
a heat source configured to increase a temperature within the oven body; and
a blower fan configured to generate a flow of air that traverses a volume defined by the oven body and an air circulation duct connected thereto.

2. The fish dehydration apparatus of claim 1, further comprising:
a demoisturizer configured to extract moisture within the oven body.

3. The fish dehydration apparatus of claim 1, further comprising:
a drainage system configured to collect fish oil.

4. The fish dehydration apparatus of claim 3, wherein the drainage system comprises a drain and an oil collection drawer located near a vertical base of the oven body.

5. The fish dehydration apparatus of claim 1, further comprising:
an oven controller configured to control the operation of the heat source and the blower fan.

6. The fish dehydration apparatus of claim 4, wherein the oven controller is further configured to monitor an environment within the oven body.

7. The fish dehydration apparatus of claim 1, wherein the fish suspension system comprises a plurality of rails and removable rods.

8. The fish dehydration apparatus of claim 7, wherein the fish suspension system further comprises a plurality of hooks.

9. A fish dehydration method, comprising:
suspending fish inside of an oven body, the oven body comprising a fish suspension system configured to suspend fish in a substantially vertical position; and
executing a dehydration process, wherein the executing of the dehydration process comprises activating a heat source and a blower fan, the blower fan being configured to generate a flow of air that traverses a volume defined by the oven body and an air circulation duct connected thereto.

10. The fish dehydration method of claim 9, further comprising;
receiving dehydration data from a user, and
wherein the dehydration process is performed in accordance with the dehydration data.

11. The fish dehydration method of claim 9, further comprising:
extracting moisture within the oven body with a demoisturizer.

12. The fish dehydration method of claim 9, further comprising:
collecting fish oil with a drainage system.

13. The fish dehydration method of claim 12, wherein the collecting of the fish oil comprises collecting fish oil with a drainage system that comprises a drain and an oil collection drawer near a vertical base of the oven body.

14. The fish dehydration method of claim 9, wherein the executing of the dehydration process is controlled using an oven controller.

15. The fish dehydration method of claim 14, wherein the executing of the dehydration process further comprises monitoring an environment within the oven body.

16. The fish dehydration method of claim 9, wherein the suspending of the fish comprises suspending the fish from a plurality of rails and removable rods of the fish suspension system.

17. The fish dehydration method of claim 16, wherein the suspending of the fish comprises suspending the fish from a plurality of hooks of the fish suspension system.

18. A fish skin dehydrated by a dehydration process comprising:
suspending fish inside of an oven body, the oven body comprising a fish suspension system configured to suspend fish in a substantially vertical position; and
executing a dehydration process, wherein the executing of the dehydration process comprises activating a heat source and a blower fan, the blower fan being configured to generate a flow of air that traverses a volume defined by the oven body and an air circulation duct connected thereto.
